(19) United States
(12) Patent Application Publication
(10) Pub. No.: US 2011/0099580 A1
(43) Pub. Date: Apr. 28, 2011

(54) INPUT DEVICE AND METHOD FOR CHANGING CHANNELS OF TELEVISION SYSTEM

(75) Inventor: LUNG DAI, Tu-Cheng (TW)

(73) Assignee: HON HAI PRECISION INDUSTRY CO., LTD., Tu-Cheng (TW)

(21) Appl. No.: 12/860,914

(22) Filed: Aug. 22, 2010

(30) Foreign Application Priority Data
Oct. 22, 2009 (CN) 200910308664.3

(51) Int. Cl. H04N 5/445

(52) U.S. Cl. 725/44

(57) ABSTRACT

An input device receives operation signals from an input interface. If the received operation signal is a first operation signal, the input device is in a first phase, where the input device records channel changes and the corresponding time. If the received operation signal is a first operation signal, the input device is in a second phase, where the input device retrieves a channel number according to a present time, and sends a change-channel command to a TV system.

### BACKGROUND

1. Technical Field

Embodiments of the present disclosure relate to user interfaces, and more particularly to an input device and method for changing channels of a television (TV) system.

2. Description of Related Art

Watching TV is one of the most popular recreational activities in the world. TV viewers have a tendency to regularly watch their favorite programs. However, TV programs are often on different channels and time slots. Scheduling of the channels and time slots has become a burden.

### BRIEF DESCRIPTION OF THE DRAWINGS

FIG. 1 is a schematic diagram illustrating one embodiment of a relationship between a TV system and an input device.

FIG. 2 is a block diagram of one embodiment of the input device capable of changing channels of the TV system.

FIG. 3 is a flowchart of one embodiment of illustrating a first phase of a method of changing channels of the TV system for the input device.

FIG. 4 is a flowchart of one embodiment of illustrating a second phase of the method of changing channels of the TV system for the input device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or Assembly. One or more software instructions in the module may be integrated in firmware, such as an EPROM. It will be appreciated that module may comprise connected logic units, such as gates and flip-flops, and may comprise programmable units, such as programmable gate arrays or processors. The units described herein may be implemented as software and/or hardware unit and may be stored in any type of computer-readable medium or other computer storage device.

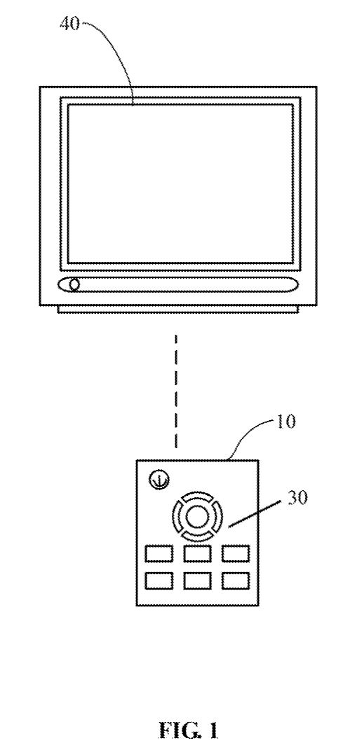

FIG. 1 is a schematic diagram illustrating one embodiment of a relationship between a TV system 40, an input device 10 and an input interface 30. In the embodiment, the input device 10 electronically communicates with the TV system 40 via radio. The input device 10 acquires a present time from the TV system 40 and sends signals to the TV system 40 so as to control the TV system 40 upon receiving the signals, such as changing TV channels of the TV system 40, for example. The TV system 40 can be cable TV or satellite TV.

In the embodiment, the input interface 30 generates signals (hereinafter “the operation signals”) that instructs the input device 10 to sends signals to the TV system 40 accordingly, so as to control the TV system 40. The operation signals include a first operation signal and a second operation signal. The input interface 30 can be a physical button array, or a touch panel, including at least one first operation signal button and a second operation signal button. The at least one first operation signal button can be a channel-navigation button or a number array of buttons. The second operation signal button can be an auto-pilot function button. In the embodiment, the input interface 30 generates the first operation signal which includes a channel number, upon pressing the at least one first operation signal button. The input interface 30 generates the second operation signal, upon pressing the second operation signal button.

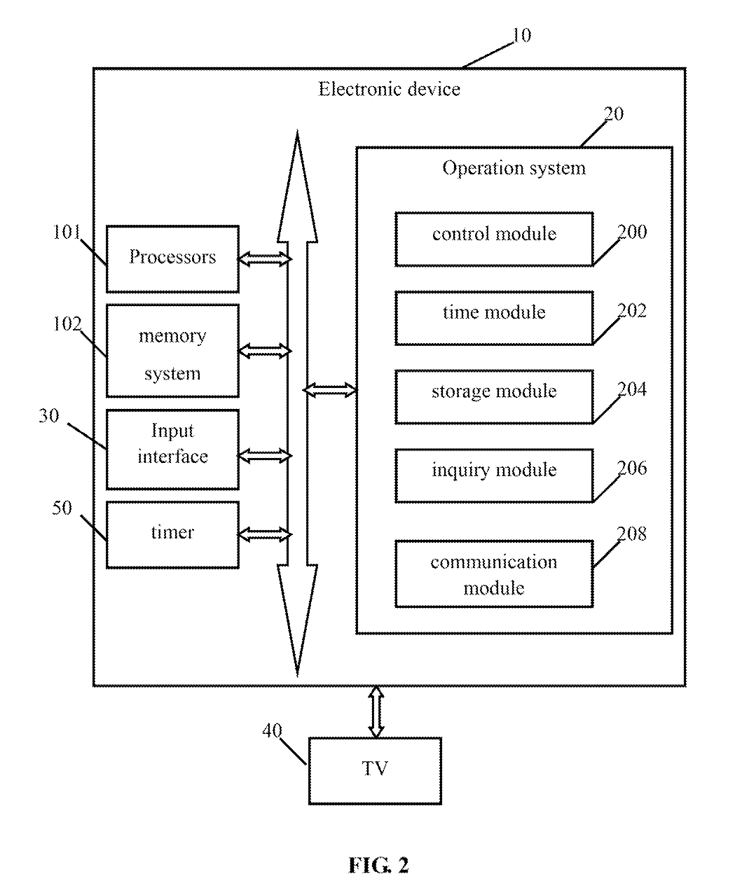

FIG. 2 is a block diagram of the input device 10 including a control module 200, a time module 202, a storage module 204, an inquiry module 206, and a communication module 208. One or more computerized codes of the modules 200-208 are stored in a memory system 102 and executed by one or more processors 101 of the input device 10.

In the embodiment, the control module 200 receives the operation signals from the input interface 30. The control module 200 determines the received operation signal is the first or second operation signal. The time module 202 acquires the present time from the TV system 40, in response to receiving the first and second operation signal. The storage module 204 records the channel number contained in the first operation signal in association with the received time from the TV system 40, in the memory system 102, in response to receiving the first operation signal. The channel number and received time are bundled in pair and maintained chronologically in a list stored in the memory system 102. The storage module 204 filters the recorded list periodically to preserve frequently accessed channel numbers.

In the embodiment, the inquiry module 206 retrieves a certain channel number from the memory system 102, in response to receiving the second operation signal. The certain channel number corresponds to the closest time, which is nearer than the present time from the TV system 40 on the recorded list. If no recorded time on the recorded list is closer than the present time from the TV system 40, the certain channel number is a default channel number, which is the most frequently accessed channel number. The input device 10 further includes a timer 50 which is initiated upon retrieving the certain channel number from the memory system 102 to indicate the inquiry module 206 when to retrieve a next channel number.

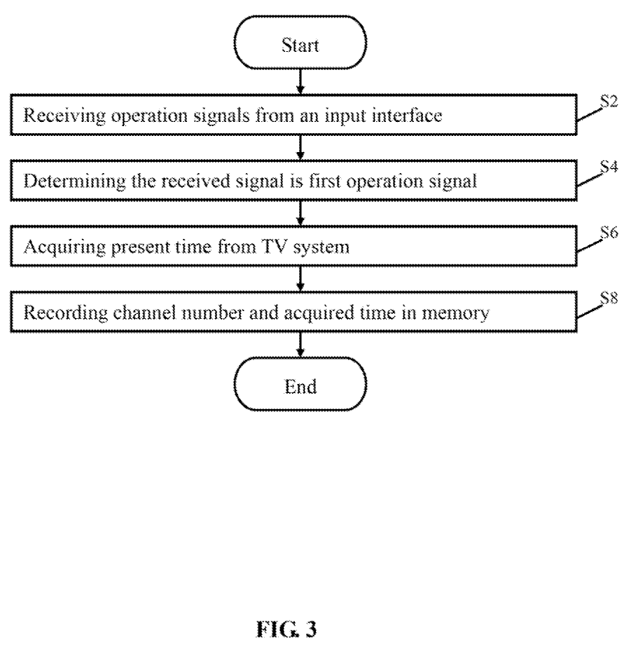

FIG. 3 is a flowchart of one embodiment of illustrating the first phase of a method of changing channels of the TV system 30 for the input device 10. In block S2, the control module 200 receives the first operation signal which includes the channel number from the input interface 30. In block S4, the control module determines the received operation signal is the first operation signal. In block S6, the time module 202 acquires the present time from the TV system 40. In block S8, the storage module 206 records the acquired time and the channel number from the first operation signal in the memory system 102.

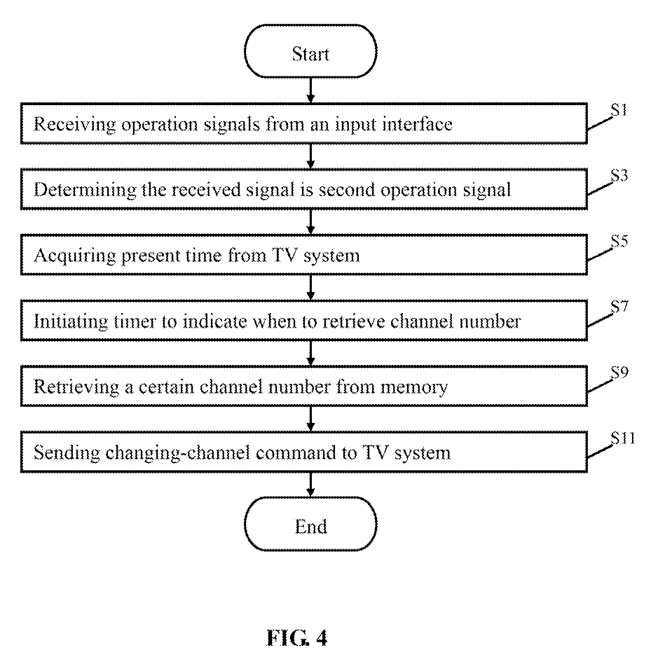

FIG. 4 is a flowchart illustrating the second phase of a method of changing channels of the TV system 30 for the input device 10. In block S1, the control module 200 receives the second operation signal. In block S3, the control module determines the received operation signal is the second operation signal. In block S5, the time module 202 acquires the present time from the TV system 40. In block S7, the inquiry 206 retrieves the certain channel number from the memory system 102. In block S9, the inquiry 206 initiates the timer 50 to indicate when to retrieve the next channel number. In block S11, the communication module 208 sends the changing-channel command, which comprises the retrieved certain channel number to the TV system 40. Depending on the embodiments, additional blocks may be added, others removed, and the ordering of the blocks may be changed.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An input device for a television (TV) system, comprising:
an input interface operable to generate a plurality of operation signals, comprising a first operation signal containing a channel number, or a second operation signal;
a memory system;
one or more processors; and
one or more programs stored in the memory system configured to be executed by the one or more processors, the one or more programs comprising:
a control module to receive one of the plurality of operation signals from the input interface and to determine the received signal is the first or second operation signal;
a time module to acquire a present time from the TV system, in response to receiving the first and second operation signal;
a storage module to record the channel number and the acquired time in the memory system, in response to receiving the first operation signal;
an inquiry module to retrieve a certain channel number from the memory system, in response to receiving the second operation signal; and
a communication module to send signals to the TV system according to the plurality of operation signals received from the input interface, so as to control the TV system, in response to receiving the plurality of operation signals.

2. The device as claimed in the claim 1, wherein the certain channel number corresponds to the closest time which is nearer than the present time from the TV system in the memory system.

3. The device as claimed in the claim 2, wherein the certain channel number is a default channel number if no recorded time in the memory system is nearer than the present time from the TV system.

4. The device as claimed in the claim 1, further comprising a timer initiated upon receiving the second operation signal, to indicate the inquiry module when to retrieve a next channel number.

5. A computerized method of changing channels of a TV system for an input device, comprising:
receiving one of a plurality of operation signals from an input interface of the input device, wherein the plurality of operation signals comprise a first operation signal containing a channel number, or a second operation signal;
determining the received signal is the first or second operation signal;
acquiring a present time from the TV system, in response to receiving the first and second operation signal;
recording the channel number and the acquired time in a memory system of the input device, in response to receiving the first operation signal;
retrieving a certain channel number from the memory system, in response to receiving the second operation signal; and
sending signals to the TV system according to the plurality of operation signals received from the input interface, so as to control the TV system, in response to receiving the plurality of operation signals.

6. The computerized method as claimed in claim 6, wherein the certain channel number corresponds to the closest time which is nearer than the present time from the TV system in the memory system.

7. The computerized method as claimed in claim 7, wherein the certain channel number is a default channel number if no recorded time in the memory system is nearer than the present time from the TV system.

8. The computerized method as claimed in claim 6, wherein the input device comprises a timer initiated upon receiving the second operation signal, to indicate when to retrieve a next channel number.

9. A computer readable storage medium having stored therein instructions, that when executed by an input device, cause the device to:
receive one of a plurality of operation signals from an input interface of the input device, wherein the plurality of operation signals comprise a first operation signal containing a channel number, or a second operation signal;
determine the received signal is the first or second operation signal;
acquire a present time from the TV system, in response to receiving the first and second operation signal;
record the channel number and the acquired time in a memory system of the input device, in response to receiving the first operation signal;
retrieve a certain channel number from the memory system, in response to receiving the second operation signal; and
send signals to the TV system according to the plurality of operation signals received from the input interface, so as to control the TV system, in response to receiving the plurality of operation signals.

10. The computer readable storage medium as claimed in claim 11, wherein the certain channel number corresponds to the closest time which is nearer than the present time from the TV system in the memory system.

11. The computer readable storage medium as claimed in claim 12, wherein the certain channel number is a default channel number if no recorded time in the memory system is nearer than the present time from the TV system.

12. The computer readable storage medium as claimed in claim 11, wherein the input device comprises a timer initiated upon receiving the second operation signal, to indicate when to retrieve a next channel number.
